(19) United States
(12) Patent Application Publication
(10) Pub. No.: US 2009/0102890 A1
(43) Pub. Date: Apr. 23, 2009

(54) INKJET PRINT HEAD

(75) Inventors: Frank W. Rohlfing, Cambridge (GB); John R.A. Ayres, Reigate (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,258

(22) PCT Filed: Sep. 1, 2005
(86) PCT No.: PCT/IB05/52871

§ 371 Date: Nov. 17, 2008

(30) Foreign Application Priority Data
Sep. 2, 2004 (GB) 0419451.0

(51) Int. Cl. B41J 2/05

(52) U.S. Cl. 347/57

(57) ABSTRACT

An inkjet print head comprises an array of print head heater circuits. Each circuit has a heater element (12) and a drive transistor (14) in series between power lines (20,22), and with a node (23) at the junction therebetween. A first capacitive element (50) is coupled between a first control signal (52) and the node (23) and a second capacitive element (54) is coupled between a second control signal (56), which is complementary to the first control signal (52), and the node (23). The two capacitive elements can be used to capacitively couple opposite step voltage changes into the circuit. These capacitive coupling effects can be used to alter the switching characteristics so as to reduce simultaneous high voltages on the gate and drain of the drive transistor.

This invention relates to thermal inkjet print heads, particularly to the drive circuitry associated with the individual print nozzles.

Thermal inkjet printing is a printing technique that is widely used. It is often referred to as bubble jet printing. The print head of an ink cartridge of a thermal inkjet printer consists of an array of tiny ink nozzles, each of which is equipped with a resistor that creates heat.

The heat vaporizes the ink in the nozzle to produce a bubble. As the bubble expands, some of the ink in the form of a droplet is pushed out of the nozzle onto the paper, or other recording medium. The collapsing bubble creates a vacuum in the nozzle, which results in a refilling of the nozzle with ink from an ink reservoir in the cartridge. The replenished ink cools the nozzle and the resistor, so that refilling and cooling prepares the nozzle for the next droplet to form when the heating resistor is next activated.

The resistor is typically connected to a drive transistor that switches it on and off in a particular sequence depending on the data to be printed. A number of different technologies can be used to form the drive circuits.

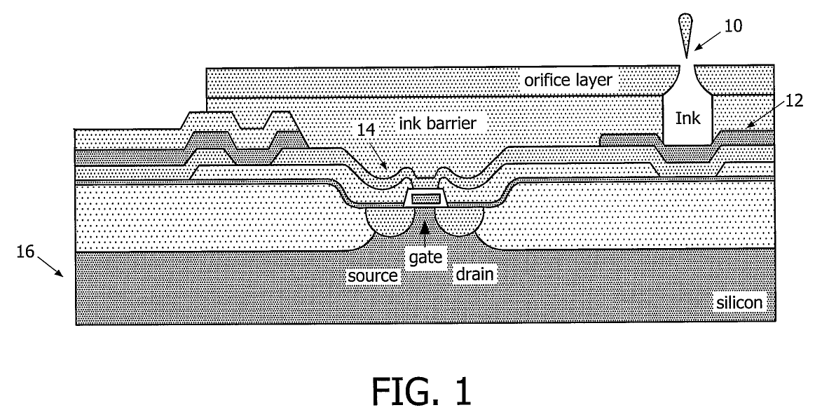

FIG. 1 shows in schematic form a first example of known print head, illustrating the nozzle 10 with a thin-film resistive heater 12 and the transistor 14 that drives it. In this example, the transistor is fabricated on a wafer 16 using a conventional silicon IC process.

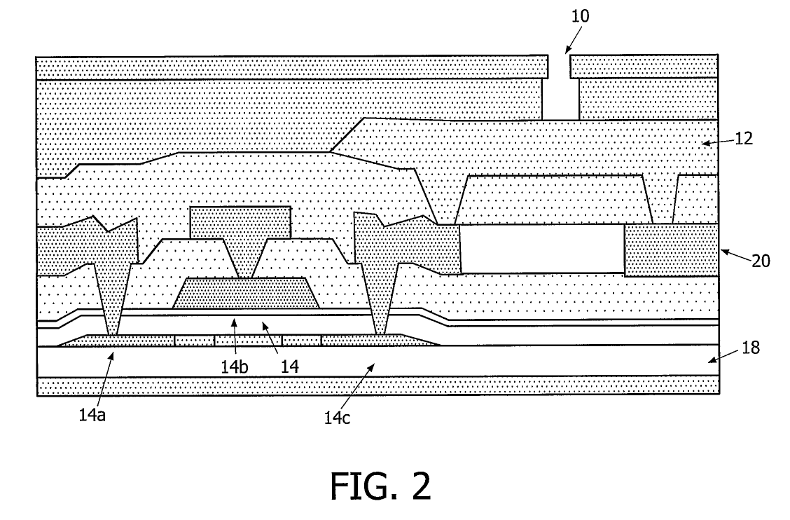

In FIG. 2, the transistor 14 is based on low-temperature poly-crystalline silicon (LTPS) technology, which allows the nozzle array with its driving transistors and other drive electronics to be fabricated on glass or other substrates 18. The source 14a, gate 14b and drain 14c are identified.

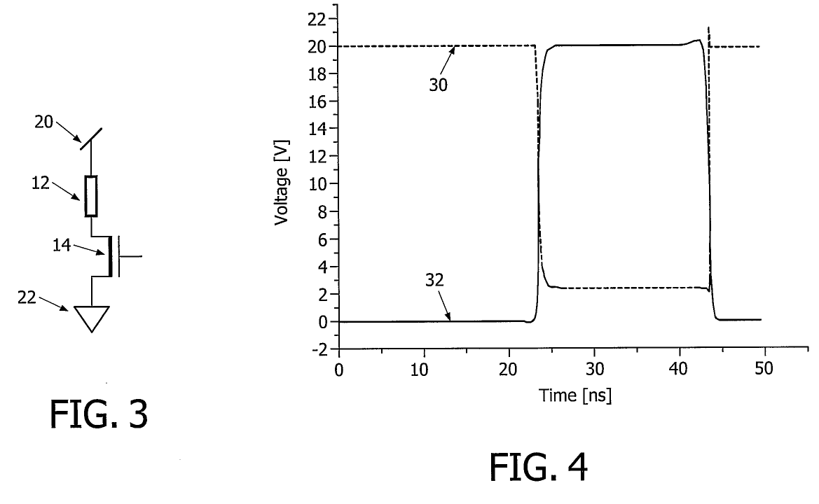

FIG. 3 shows the corresponding circuit schematic for the circuit of an individual print nozzle. The circuit comprises the resistor heater 12 in series with the drive transistor between a high power rail 20 (V_{DD}) and ground 22, or other low power rail voltage. The circuit is shown implemented with an n-type transistor.

If the gate voltage of the n-type transistor 14 is low, the voltage V_{DD} drops across the channel of the transistor and the heating resistor 12 remains cold. If the gate voltage is high, current flows resulting in heat dissipation and droplet formation in the nozzles.

FIG. 4 shows the switching characteristics for the nozzle circuit in FIG. 3.

Plot 30 shows the drain voltage, which is the voltage at the junction between the resistor 12 and transistor 14, and plot 32 shows the transistor gate voltage. The Figure shows a transition from a low to high gate voltage followed by a transition from a high to low gate voltage. The drain voltage switches in complementary manner.

The channel width of the transistor has to be sufficiently large so that the voltage V_{DD} drops almost entirely across the heater when the gate is high. For some printing applications, the power required for droplet formation can be as high as several Watts per nozzle. Given that the nozzle pitch for most applications is only of the order of 20 to 100 μm, the power per nozzle is very high. This power requires a very wide transistor, and one of the key issues with thermal inkjet printing is to fit the transistor into the small nozzle pitch. This is particularly the case for print heads in which the driving transistor is made on glass using LTPS transistors rather than conventional CMOS technology on silicon wavers. This is because LTPS transistors have a higher threshold voltage and a lower mobility and therefore deliver a lower current per channel width than conventional CMOS transistors.

One way of reducing the required channel width is to increase the voltage VDD. In order to keep the power constant, the resistance of the heater has to be increased as well, and this means that a transistor with a smaller width will be sufficient to guarantee that its on-resistance is still small compared to the resistance of the heater. As the resistance of the heater scales quadratically with the voltage V_{DD} for fixed power, the required transistor width reduces with the inverse of the square of V_{DD}. Hence, increasing V_{DD} is a very effective way to ensure that the transistor fits to a reduced nozzle pitch. This is particularly important for the use of LTPS transistors to drive the nozzles.

However, whilst increasing VDD reduces the size of the transistor, it also reduces its lifetime as the higher voltage drop across the channel results in transistor degradation due to avalanching and hot-carrier effects.

The highest degree of degradation occurs in the transient state of the transistor, because in this state gate and drain voltage are at a relatively high level simultaneously, and the power dissipated in the transistor reaches its maximum.

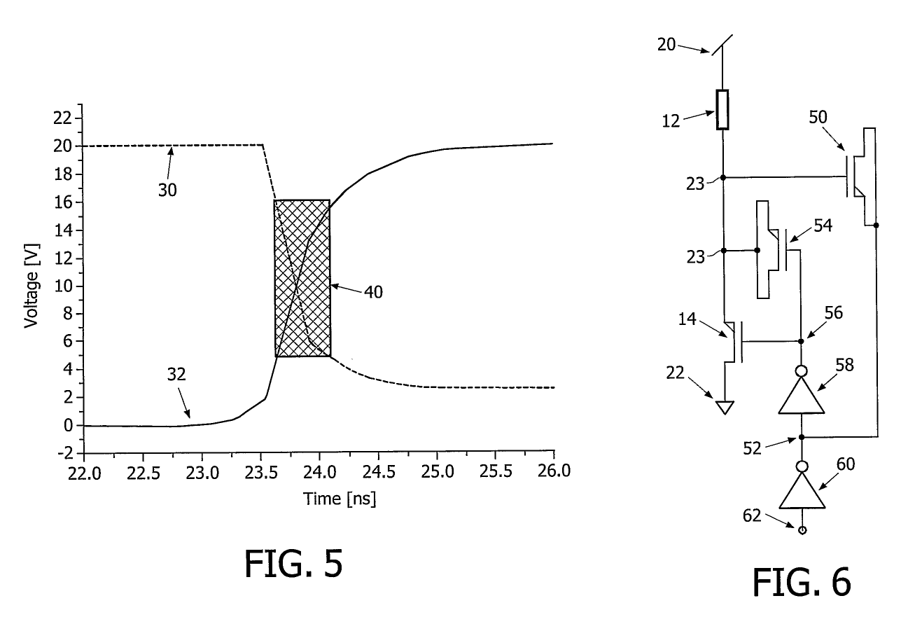

FIG. 5 shows the switching-on process of FIG. 4 on a larger scale. When the gate voltage switches, there is a delay before the drain voltage reacts, as a result of the threshold voltage of the transistor. As a result, the gate and drain voltages are simultaneously high during the switching operation.

The shaded area 40 in FIG. 5 represents the time interval during which both gate and drain voltage have a relatively high value, resulting in electrical degradation of the transistor. Degradation in the transient state is a major problem because of the high frequency at which print nozzles have to be switched. Even higher frequencies will be used in future print cartridge generations in order to increase printing speed. Hence, transistors will pass through the transient state very often during the lifetime of an ink cartridge.

There is therefore a need for an inkjet print head driver circuit that enables small dimension transistors to be used whilst limiting transistor degradation at the voltages required.

According to the invention, there is provided an inkjet print head comprising an array of print head heater circuits, each associated with a respective print head nozzle, wherein each heater circuit comprises:

a heater element and a drive transistor for driving current through the heater element, the heater element and the drive transistor connected in series between power lines, and with a node at the junction therebetween;

a first capacitive element coupled between a first control signal and the node; and

a second capacitive element coupled between a second control signal, which is complementary to the first control signal, and the node.

The two capacitive elements of the circuit of the invention are used to capacitively couple opposite step voltage changes into the circuit. These capacitive coupling effects can be used to alter the switching characteristics so as to reduce the simultaneous high voltages on the gate and drain of the drive transistor.

The drive thus prevents that the gate and drain voltage of the transistor are at a high level at the same time, thereby reducing transistor degradation, and permitting high power supply voltages to be used. This in turn enables the channel dimensions to be reduced, so allows reduced nozzle pitch.

The second control signal is preferably provided by an inverter which receives as input the first control signal. This inverter performs the function not only of providing the two complementary control signals, but also acts as a delay element which functions in the circuit to alter the timing of the voltage waveforms at different points in the circuit so as to reduce simultaneous high gate and drain voltages.

The first control signal can be provided by a second inverter which receives as input a nozzle control input. In this way, the circuit can receive a conventional drive signal.

The output of the (first) inverter, which provides the second control signal, is preferably coupled to the gate of the drive transistor. Thus, the second control signal is the normal drive signal.

The first and second capacitive elements each preferably have voltage-dependent capacitance. This enables the effect of each capacitor in the circuit to depend on whether the control signal is a rising edge or a falling edge. This asymmetry enables the circuit to improve the circuit operation both for on-off waveforms and for off-on waveforms.

The first and second capacitive elements preferably each have a capacitance which increases with the voltage on one of the capacitor terminals. They can be implemented as NMOS capacitors.

The invention also provides a method of driving an inkjet print head nozzle comprising a heater element and a drive transistor in series between power lines, and with a node at the junction therebetween, the method comprising:

capacitively coupling a first control signal to the node;

capacitively coupling a second control signal, which is a complementary and delayed version of the first control signal, to the node; and

using the second control signal to drive the gate of the drive transistor.

Examples of the invention will now be described in detail with reference to the accompanying drawings, in which:

FIG. 1 shows schematically a first known print head configuration;

FIG. 2 shows schematically a second known print head configuration;

FIG. 3 is a schematic circuit diagram of the print head nozzle drive circuit;

FIG. 4 shows the gate and drain voltages of the drive transistor of FIG. 3 during switching;

FIG. 5 shows the switching-on process of FIG. 4 in greater detail;

FIG. 6 shows schematically a circuit of the invention using NMOS capacitors;

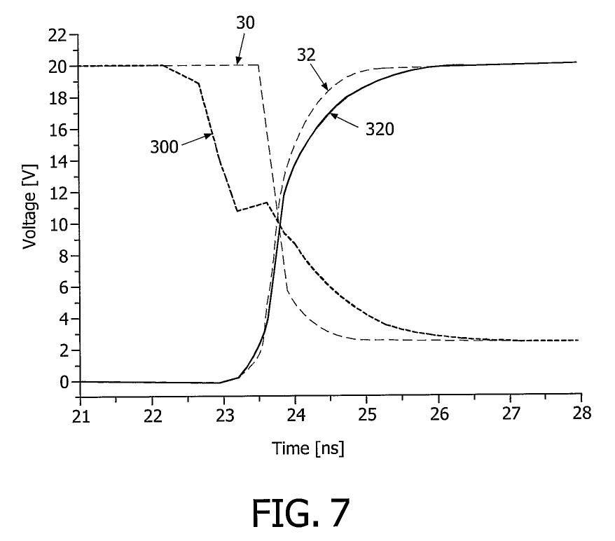

FIG. 7 shows the transient switching behaviour of the circuit of FIG. 6 when the heater switches on;

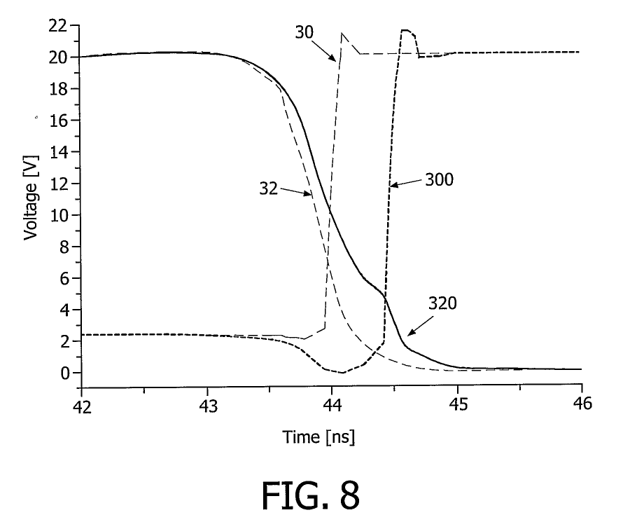

FIG. 8 shows the transient switching behaviour of the circuit of FIG. 6 when the heater switches off; and

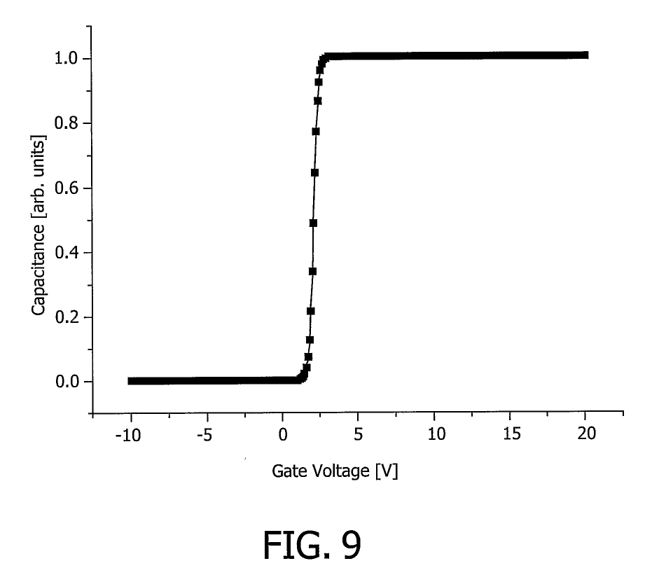

FIG. 9 shows the gate capacitance as a function of the gate voltage for source and drain voltages of 0V for the capacitors used in the circuit of FIG. 6.

The invention provides an inkjet print head heater circuit in which first and second capacitive elements are used to couple first and second complementary control signals into the circuit, at the junction between the heater element and the drive transistor. These capacitors alter the switching characteristics so as to reduce the simultaneous high voltages on the gate and drain of the drive transistor.

FIG. 6 shows the nozzle heater circuit of the invention. The circuit again comprises a heater element 12 and a drive transistor 14 in series between power lines 20, 22, and with a node 23 at the junction.

A first capacitive element 50 is coupled between a first control signal 52 and the node 23, and a second capacitive element 54 is coupled between a second control signal 56, which is complementary to the first control signal 52, and the node 23. The second control signal is the signal applied to the gate of the transistor 14.

The two complementary control signals, at 52 and 56 are generated from a single input to the circuit, by means of a first buffer inverter 58. In order that the conventional (rather than an inverted) control signal can be provided to the circuit, a second buffer inverter 60 is provided between the circuit input 62 and the first buffer inverter 58.

In this way, a buffer chain 60, 58 is used to drive the transistor gate. The buffer chain is connected to conventional logic circuits that provide the printing control signal for the transistor.

The capacitive elements 50, 54 are implemented as NMOS capacitors with source and drain coupled together. Signal 52 connects to the source/drain of NMOS capacitor 50, whilst signal 56 connects to the gate of NMOS capacitor 54. The other terminals of the two NMOS capacitors connect to node 23.

These capacitors couple negative charge into the drain of the transistor 14, namely the node 23, whenever the logic signal changes. In particular, the capacitors are arranged to reduce the voltage at the node 23 during critical timings of the circuit switching operation. The circuit can be optimised so that a sufficient voltage reduction occurs at the node 23, which prevents electrical degradation of the transistor.

The first and second capacitive elements 50, 54 each have voltage-dependent capacitance. This enables the effect of each capacitor in the circuit to depend on whether the control signal is a rising edge or a falling edge. This asymmetry enables the circuit to improve the circuit operation both for on-off waveforms and for off-on waveforms, as will be apparent from the discussion below. NMOS capacitors have a capacitance which increases with the voltage on one of the capacitor terminals.

FIGS. 7 and 8 show simulated results of the operation of the circuit of FIG. 6 for an LTPS transistor process on glass with a threshold voltage of approximately 2V and −2V for the n-type and the p-type transistors, respectively. The power rail voltage V_{DD} as well as the high logic voltage level at the input 62 are 20V. The resistance of the heater is 1 kΩ and the width of the transistor is chosen such that approximately 90% of V_{DD} drops across the resistor when the gate is at 20V. Hence, the power dissipated by the heater is approximately 0.4 W.

FIG. 7 shows a transient analysis of the switching-on process.

Plots 30 and 32 represent the drain and gate voltages for the conventional circuit (of FIG. 3), and Plots 300 and 320 represent the drain and gate voltages for the circuit of the invention (of FIG. 6).

In the absence of the capacitive elements of the invention, the drain voltage remains high at 20V and only starts decreasing at a point in time when the gate voltage has already reached 3V, which is above the TFT threshold voltage of 2V. By the time the gate voltage has increased to 6V, i.e. has reached three times the threshold voltage, the drain voltage is still at a relatively high value of 16V. Depending on the TFT architecture, a combination of gate voltage of 6V and drain voltage of 16V can lead to serious electrical degradation of the TFT.

The circuit of the invention enables the drain voltage to drop to approximately 11V before the gate voltage starts to increase from its initial value of 0V. This drop in drain voltage is due to the capacitive coupling of the capacitor 50.

The drain voltage remains at approximately 11V for a short period of time and then decreases at a point in time at which VG has just approached 5V. Hence, in the circuit of the invention, gate and drain voltages of 5V and 11V, respectively, are obtained which is considerably lower than the above values of 6V and 16V in the conventional circuit.

The simulation results of FIG. 7 clearly demonstrates that the capacitive coupling effects reduce the extent to which the gate and drain are at high values simultaneously in the transient state. This reduction leads to TFT stability improvements, or, alternatively allows the circuit to be operated at higher voltages before degradation occurs.

The transient behaviour in the switching-on process can be understood as follows. In the off state, the control signal 52 is high. The capacitance is low at the beginning because at that time signal 52 and node 23 are at 20V (giving a low relative grate voltage). However, very soon the capacitance becomes high, once signal 52 has dropped. When this control signal goes low, the capacitor 50 couples a negative voltage to the node 23. Due to the delay introduced by the buffer inverter 58, this coupling will occur slightly before the gate of the transistor (node 56) goes high. The capacitor 54 will not couple any charge into the node 23 until its channel has become conducting, which happens once the gate voltage exceeds the source/drain voltage by an amount which is approximately equal to the TFT threshold voltage. In other words, the capacitance of the capacitor 54 is low during the first half of the switching process, during which time capacitance of the capacitor 50 is high and couples negative charge into node 23. A simultaneous occurrence of high drain and gate voltage is thus prevented.

FIG. 8 demonstrates a transient analysis of the switching-off process.

Again, plots 30 and 32 represent the drain and gate voltages for the conventional circuit (of FIG. 3), and Plots 300 and 320 represent the drain and gate voltages for the circuit of the invention (of FIG. 6).

In the conventional circuit, there is again a significant region in which the gate and drain voltage are at a relatively high level simultaneously.

However, the circuit of the invention enables the drain voltage 300 to decrease as soon as the gate voltage starts to decrease. It then reaches a minimum value of approximately 0V, and only returns to its initial value when the gate voltage has already fallen to 4V, at which point stability is not an issue.

This transient behaviour can be explained as follows. In the on state, the gate voltage of the capacitor 54 is well above its channel voltage, which means that charge is present in the channel and the capacitance is high. When the gate voltage falls, negative charge is pumped from the channel of the capacitor 54 into the node 23, resulting in a minimum in the drain voltage as can be seen in FIG. 8. Because of the delay introduced by the buffer inverter 58, the control signal 52 will go high before the gate voltage of capacitor 50 (node 23) starts to increase. This turns capacitor 50 into the low state before node 56 changes. Hence, the increase in the voltage on the control signal 52 when the transistor switches off does not couple a positive voltage to the node 23 as a result of the relatively low capacitance of the capacitor 50 at that time.

The capacitive-coupling induced voltage reductions described above and illustrated in FIGS. 7 and 8 can be achieved for both transitions by virtue of the voltage-dependent characteristics of the capacitors, which enable one to dominate over the other for each transition.

The capacitance of the NMOS capacitor is illustrated in FIG. 9. The capacitance is zero in the off state and then increases sharply once the gate voltage reaches the sub-threshold region.

The simulation results in FIGS. 7 and 8 clearly demonstrate that the two NMOS capacitors dramatically reduce the drain voltage both when the transistor activates and deactivates the heating resistor. This eliminates electrical degradation of the transistor and enables an increase of the voltage V_{DD}. As mentioned above, if V_{DD} can be increased without compromising stability, the transistor width can be reduced, and this translates into a pitch reduction of neighbouring nozzles. Given the quadratic dependence between V_{DD} and transistor width for fixed power, increasing V_{DD} is a very effective way to reduce nozzle pitch, which is one of the key technical issues with thermal inkjet printing. The NMOS capacitor circuit presented here addresses this key technical issue. Alternatively, PMOS capacitors can be used to achieve the same effect.

A single circuit has been described in detail above. However, the invention can be implemented with different circuits, and provides more generally the concept of coupling oppositely changing pulse edges into the drive circuit with dynamic voltage-dependent capacitors in order to reduce the occurrence of simultaneous high gate and drain voltages.

Various modifications will be apparent to those skilled in the art.

1. An inkjet print head comprising an array of print head heater circuits, each associated with a respective print head nozzle, wherein each heater circuit comprises:
a heater element (12) and a drive transistor (14) for driving current through the heater element, the heater element (12) and the drive transistor (14) connected in series between power lines (20,22), and with a node (23) at the junction therebetween;
a first capacitive element (50) coupled between a first control signal (52) and the node (23); and
a second capacitive element (54) coupled between a second control signal (56), which is complementary to the first control signal (52), and the node (23).

2. An inkjet print head as claimed in claim 1, wherein the second control signal (56) is provided by an inverter (58) which receives as input the first control signal (52).

3. An inkjet print head as claimed in claim 2, wherein the first control signal (52) is provided by a second inverter (60) which receives as input a nozzle control input (62).

4. An inkjet print head as claimed in claim 2, wherein the output of the inverter (58), which provides the second control signal (56), is coupled to the gate of the drive transistor (14).

5. An inkjet print head as claimed in claim 1, wherein the first and second capacitive elements (50,54) each have voltage-dependent capacitance.

6. An inkjet print head as claimed in claim 5, wherein the first and second capacitive elements (50,54) each have a capacitance which increases with the voltage on one of the capacitor terminals.

7. An inkjet print head as claimed in claim 5, wherein the first and second capacitive elements (50,54) each comprise NMOS capacitors.

8. An inkjet print head as claimed in claim 7, wherein the gate of one NMOS capacitor (50) and the source/drain of the other NMOS capacitor (54) is connected to the node (23), and the other terminal of each NMOS capacitor is connected to the respective control signal (52,56).

9. An inkjet print head as claimed in claim 1, wherein the heater element (12) comprises a resistor.

10. A method of driving an inkjet print head nozzle comprising a heater element (12) and a drive transistor (14) in series between power lines (20,22), and with a node (23) at the junction therebetween, the method comprising:
capacitively coupling a first control signal (52) to the node (23);
capacitively coupling a second control signal (56), which is a complementary and delayed version of the first control signal (52), to the node (23); and
using the second control signal (56) to drive the gate of the drive transistor (14).

11. A method as claimed in claim 10, wherein the steps of capacitively coupling comprise using capacitive elements (50,54) having voltage-dependent capacitance.
